(19) United States
(12) Patent Application Publication
(10) Pub. No.: US 2023/0382174 A1
(43) Pub. Date: Nov. 30, 2023

(54) Self Leveling Trailer and Loading Ramps

(71) Applicant: CONPLANT PTY LTD., lngleburn, New South Wales (AU)

(72) Inventor: Ian Robert Coleman, New South Wales (AU)

(73) Assignee: CONPLANT PTY LTD., lngleburn, New South Wales (AU)

(21) Appl. No.: 18/248,980

(22) PCT Filed: Oct. 13, 2021
(86) PCT No.: PCT/AU2021/051198

§ 371 Date: Apr. 13, 2023

(30) Foreign Application Priority Data
Oct. 14, 2020 (AU) 2020903728

(51) Int. Cl. B60G 17/017; B62D 53/06; B60P 1/43; B60P 3/06; B60S 9/10

(52) U.S. Cl. CPC B60G 17/017; B62D 53/062; B62D 53/067; B60P 1/435; B60P 3/062; B60S 9/10; B60G 2300/042; B60G 2800/204; B60G 2600/202; B60G 2800/912

(57) ABSTRACT

A heavy vehicle and machinery trailer having: (i) a trailer base with wheels and suspension; (ii) a trailer bed supported on the trailer base by the suspension; (iii) loading ramps connected to the trailer bed where the suspension, or other methods such as hydraulically operated landing legs, are adapted to allow an operator to alter the pitch and/or roll angle of the trailer bed relative to the ground surface and wherein where the loading ramps are adapted to have varying lengths such that the ramps can be evenly pitched when they are extended to the ground on a sloped surface. The trailer has a hydraulic system under the control of an electrical controller which is operated by a user. The electrical controller has a preset matrix of safe loading and unloading parameters which it uses to determine whether the sensed state of the trailer is safe for loading or unloading.

### CROSS-REFERENCE TO PRIOR FILED APPLICATIONS

This application is the United States National Stage of International Application No. PCT/AU2021/051198, filed on Oct. 13, 2021, which claims priority to Australian Patent Application No. 202090378, filed on Oct. 14, 2020, which are hereby incorporated by reference in their entireties.

### TECHNICAL FIELD

The field of the present invention is in materials and methods for transporting motor vehicles and machinery. More particularly the invention is in the field of self-levelling vehicle trailers for transporting large road machinery and plant equipment.

### BACKGROUND ART

When the use of large and heavy machinery or equipment is involved, such goods must be transported to a site using a vehicular trailer as they are not designed for travelling long distances. Conventional trailers for these purposes, or low loaders, have flat beds on the trailer surface together with ramps which may be added to the rear bed of the trailer or may form part of the trailer and are pivoted down from a stowed position where they are generally normal to the plane of the bed of the trailer. In use, the vehicle or machinery to be transported is driven up onto the trailer bed by way of the ramps. Such a prior art trailer is shown in FIG. 1 with an excavator on its trailer bed. Such trailers have deficiencies, however, particularly when it comes to loading and unloading said machinery and equipment which often have load bearing surfaces which are metal. For example, excavators of the sort depicted in FIG. 1 have steel tracks. Such machinery can slide off the bed of the trailer and roll over if the trailer is not on flat ground, causing damage to the vehicle and death or injury to the driver of the fallen vehicle.

To minimise this risk, when loading equipment onto trailers it is customary to only do so on a flat or minimally sloping surface. Loading is normally undertaken when the trailer bed is horizontal in both pitch (front to back) and roll (side to side) relative to the ground. However, this does reduce the available places in which such loading can take place. In many cases with road maintenance machinery including vibratory rollers and excavators, such loading needs to take place at the side of the road where there is often a camber.

The problem of non-horizontal trailer beds has been addressed in certain adjustable trailers, whereby the trailers have the means to allow an operator to manually adjust the pitch and roll angle of the trailer to ensure a horizontal trailer bed surface. This process relies on the operator's eye to determine that the trailer is in fact horizontal.

Using a levelling system creates a flat trailer bed surface, but this causes its own problems. Trailer loading ramps are conventionally comprised of two (may be more or less) ramps that pivot off the rear of the trailer bed. These ramps will lower until they hit the ground, and regardless of whether the surface of the trailer is flat/horizontal, if the ground is sloped this causes the ramps to be uneven and of different angles. This again creates a risk of side slippage whilst the machinery is being driven up the ramps.

It is an object of the present invention to produce a trailer that overcomes at least some of the deficiencies of the prior art or which offers an improved design over prior art trailers. Other objects and advantages of the present invention will become apparent from the following description, taken in connection with the accompanying drawings, wherein, by way of illustration and example, an embodiment of the present invention is disclosed.

### DISCLOSURE OF INVENTION

Loading and unloading self-propelled machinery, equipment and vehicles (hereafter referred to as ‘Equipment’) using their own power, onto and off trailers (and rigid trucks), often involves risks associated with uneven ground. These risks increase in certain circumstances, including but not limited to, when frictional contact is reduced due to a loss of traction, i.e. wheel spin, particularly where a cross fall or sideways slope exists, i.e. road camber.

This invention greatly reduces loading and unloading risk by:
1. levelling the trailer and the trailer loading ramps; and
2. limiting or eliminating suspension movement, therefore limiting or eliminating loading ramps and trailer deck rocking motion.

According to one aspect of the invention, there is provided a heavy vehicle and machinery trailer, the trailer comprising:
a trailer base having a plurality of wheels and suspension means;
a trailer bed supported on the trailer base by the suspension means;
loading ramps connected to the trailer bed;
wherein the suspension means, or other methods such as hydraulically operated landing legs, are adapted to allow an operator to alter the pitch and/or roll angle relative to the ground surface and wherein the loading ramps are adapted to have varying lengths such that when they are extended to the ground on uneven surface, the lengths can be adjusted so that the ramps are evenly pitched.

Preferably the suspension means includes air bag suspension, spring suspension or hydraulic suspension.

Preferably, the trailer further comprises widening means which allow an operator to widen the trailer bed.

Even more preferably the trailer further comprises a controller for controlling the actuation of the suspension means, widening means and/or ramp extension.

More preferably the controller is in electrical connection to a plurality of sensors for sensing at least the pitch and roll of the trailer bed and ramps.

Still more preferably the trailer further comprises a hydraulic system under the control of an operator to actuate the suspension, ramps and widening means.

Even more preferably the hydraulic system is operated by a control system which is in connection to a plurality of sensors, outputs and indicators. Preferably the control system is able to be operated remotely via way of a connected mobile device including smartphone.

In a second aspect of the invention there is provided a method of loading and unloading heavy plant or machinery onto a trailer, the method comprising:
1. Adjust the pitch and roll angle of the trailer bed until horizontal;
2. Lower ramps of the trailer;
3. When the first ramp on higher ground makes contact, match the pitch angle of the second ramp to the first ramp and extend the ramp foot until it becomes grounded, and
4. Load the vehicle (optionally with winch).

Preferably, the method includes the additional steps of:—
determining whether it is safe to unload or load the trailer (optionally based on the specific type and model of machinery to be loaded);
levelling the trailer bed; and/or
lowering and extending the ramps; and/or
preparing the trailer to drive on the road after loading.

### BRIEF DESCRIPTION OF THE DRAWINGS

FIG. 1 is a perspective drawing of a conventional trailer with an excavator on the trailer bed;

FIG. 2 is a rear view of the unladen trailer of FIG. 1 on sloping ground, with the ramps pivoted up;

FIG. 3 is a rear view of the unladen trailer of FIG. 1 on sloping ground with the ramps pivoted down;

FIG. 4 is a partial perspective view of a trailer on sloping ground according to a first embodiment;

FIG. 5 is a side view of the trailer of FIG. 4;

FIG. 5a is a close-up view of the bounded box b of the trailer of FIG. 5 showing the varying ground levels of each ramp and ramp tip;

FIG. 6a is a rear view of the trailer of FIG. 4 on uneven ground showing the positioning of the ramps;

FIG. 6b is a rear view of the trailer of FIG. 4 on uneven ground after the widening of the trailer bed;

FIG. 7a is a cross sectional view taken along lines A-A of the trailer of FIG. 5 depicted on uneven ground;

FIG. 7b is a cross sectional view taken along lines A-A of the trailer of FIG. 5 after the widening of the trailer bed;

FIG. 8 is a schematic of the control panel of the vehicle controller of the trailer;

FIG. 9 are parameters for various switches of the controller of the trailer;

FIG. 10 is a panel of indicators associated with the controller of the trailer;

FIG. 11 is a schematic of the wiring associated with the sensors, controller and actuators of the trailer;

FIG. 12 is a schematic of a control system according to a second embodiment of the first aspect of the invention.

### DETAILED DESCRIPTION

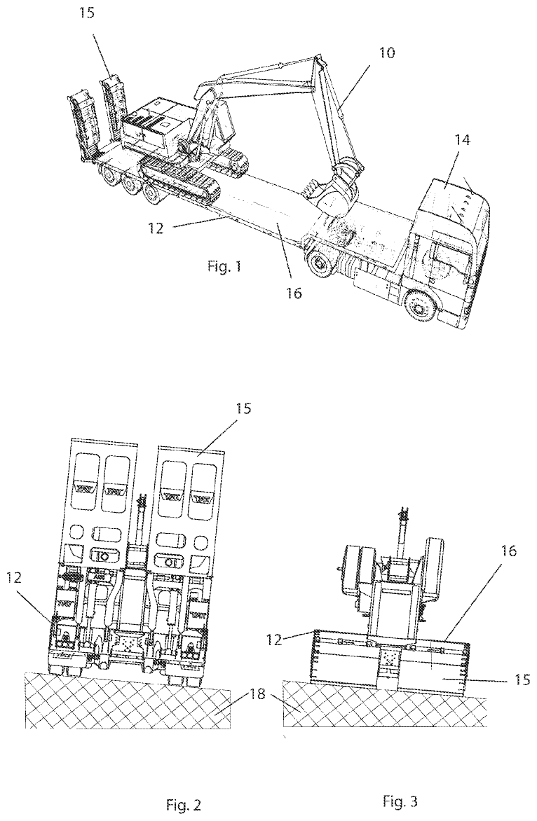

Referring to FIGS. 1 to 3 there is depicted an excavator 10 on the bed 16 of a trailer 12 which is being pulled by a truck or prime mover 14. Trailer 12 is an example of a conventional trailer that has pivoting ramps 15 at the rear end and which are incapable of levelling their bed 16. Consequently, when they are located on sloping ground 18, as shown in FIGS. 2 and 3, the bed 16 has a corresponding slope. This makes it dangerous to load and retain earthmoving equipment and heavy vehicles on the back of bed 16, particularly if they have steel driving surfaces such as the tracks of excavator 10. Given that most roads have a road shoulder with significant camber, conventional trailers are ill suited to being used roadside where they are very often required to be used. This leads to them being used inappropriately in dangerous conditions, or it means time is lost moving the machinery to a position that is more suitable for the use of conventional trailer 12.

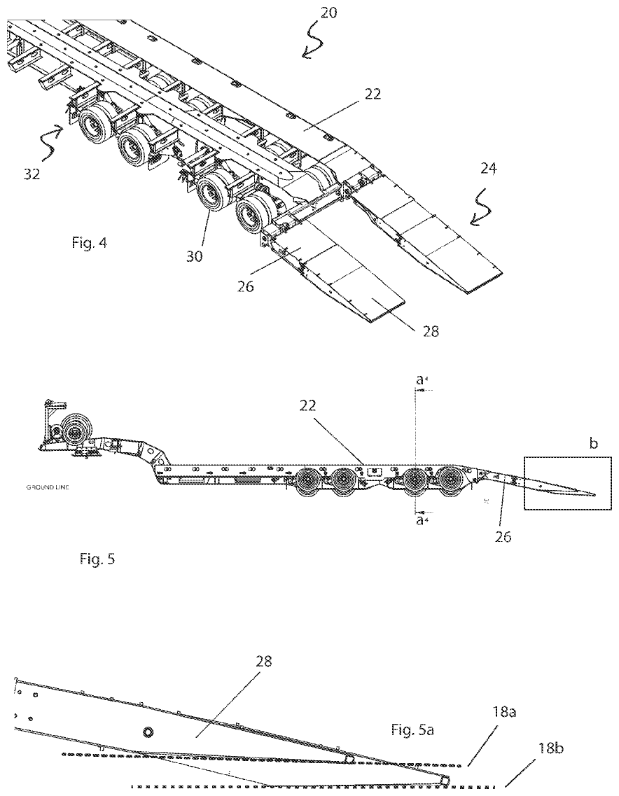

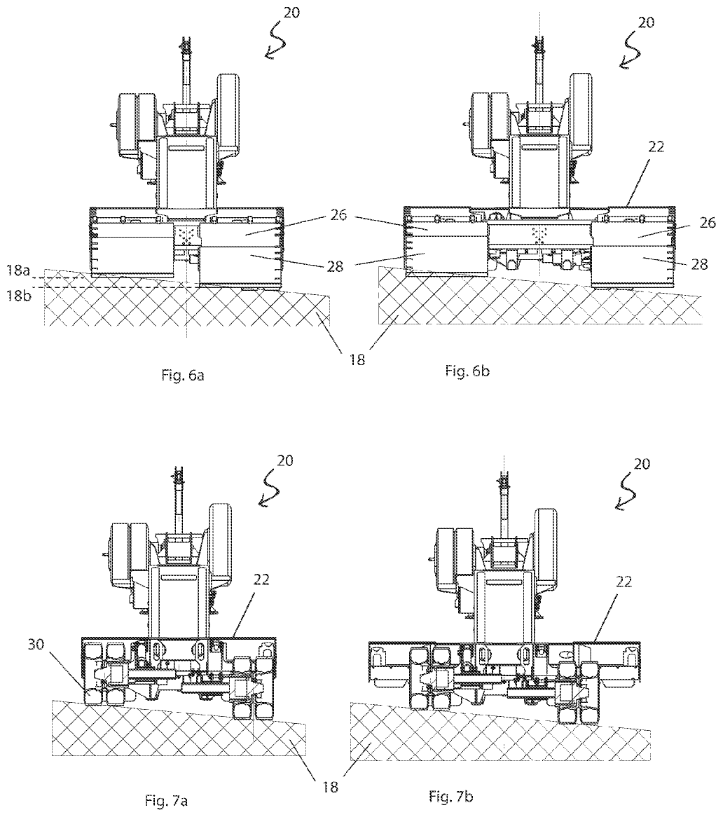

Turning to FIG. 4 there is provided a multi axle trailer 20 which comprises the first aspect of the invention. The trailer 20 is adapted to be able to adjust the pitch and roll angles of the bed 22 of trailer 20. It does this by adjusting the trailer suspension of which sits between the trailer base 32 containing the wheels 30 and drivetrain (not shown) and the bed 22. Many types of suspension can be incorporated into the invention including air bag suspension, hydraulic suspension and spring suspension. Where levelling using suspension is not practical other means such as hydraulic landing legs can be used. Trailer 20 also has ramps 24 which are telescoping as between ramp base 26 and ramp foot 28. Ramp foot 28 can be extended outwardly along ramp base 24 to provide for an adjustable length of ramp 24. The adjustable length of ramps 24 provides particular utility when trailer 20 is situated on sloping ground 18 as shown in FIGS. 6a to 7b as the ramps can be lengthened or shortened to accommodate the slope in the ground once the bed of the trailer has been made level from a roll perspective. If the levelling feature of the trailer has been utilised to accommodate sloping ground then the ramps will need to accommodate this as well as imply extending equal length ramps will result in the ramp on higher ground 18a hitting the ground first before the ramp on the lower ground 18b hits the ground. This causes the ramps to be uneven in terms of pitch angle. By extending ramp foot 28 outwardly on the ramp on the lower ground 18b such that the ramp 24 is longer, the same pitch angle can be maintained on the ramps 24 despite the sloping ground 18. This is demonstrated in the close-up portion b of FIG. 5 shown as FIG. 5a where it can be seen the distal ramp extends below the higher ground line 18a to the ground level of 18b. This results in parallel ramps of equal pitch angle which provide for a much safer loading of vehicles and machinery on the rear of trailer 20. Ramp foot 24 is actuated into position using mechanical actuation under electronic control. Preferably a hydraulic cylinder driven by a hydraulic pump under computer control. In use, which will be described in more detail below, the operators drop the ramps 24. When the first ramp hits the higher ground, the second ramp stops pivoting and instead starts to extend outwardly until it too touches the ground. This ensures parallel ramps of even pitch for safe loading and unloading.

In addition to be adapted to adjust the pitch and roll angles (relative to the ground), trailer 20 is also adapted to be widened such that the trailer bed 22 can accommodate machinery and work vehicles that are wider than the un-widened bed 22 of trailer 20.

We now turn to the second embodiment of the first aspect of the invention, a computer controlled and remotely operable trailer 20. A significant cause of accidents on road work sites is caused by operator error. It is a further object of the invention to provide the operators with a system for controlling the operation of the trailer 20 in a manner that is dangerous. That is, that the trailer 20 has a control system that removes from the operator, or substantially reduces, the ability to put the trailer to work in conditions that are likely to be unsafe.

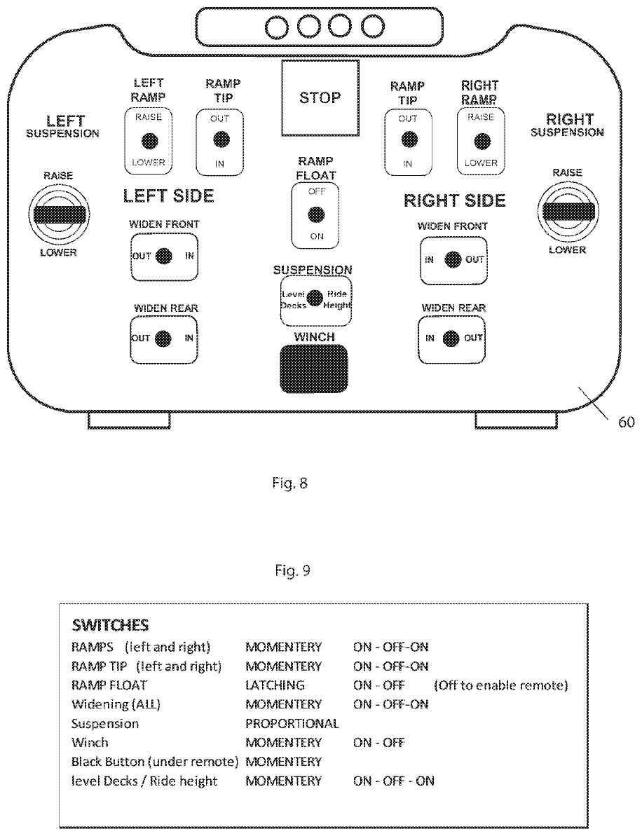

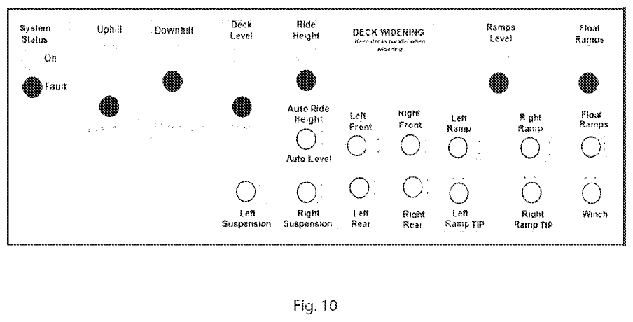

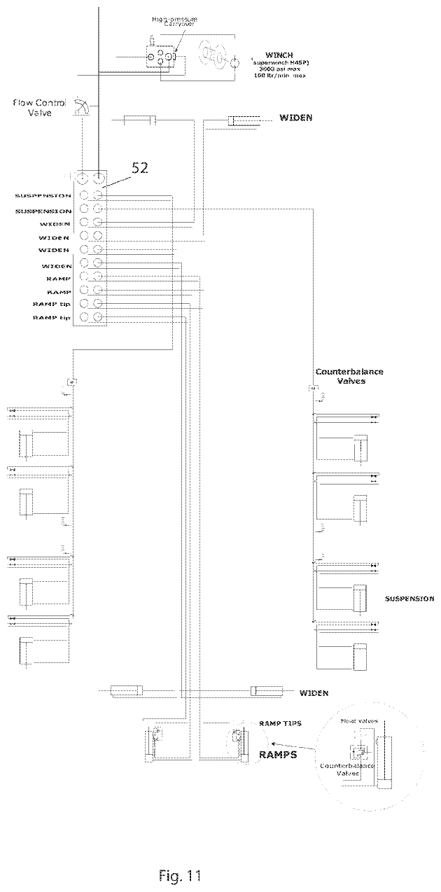

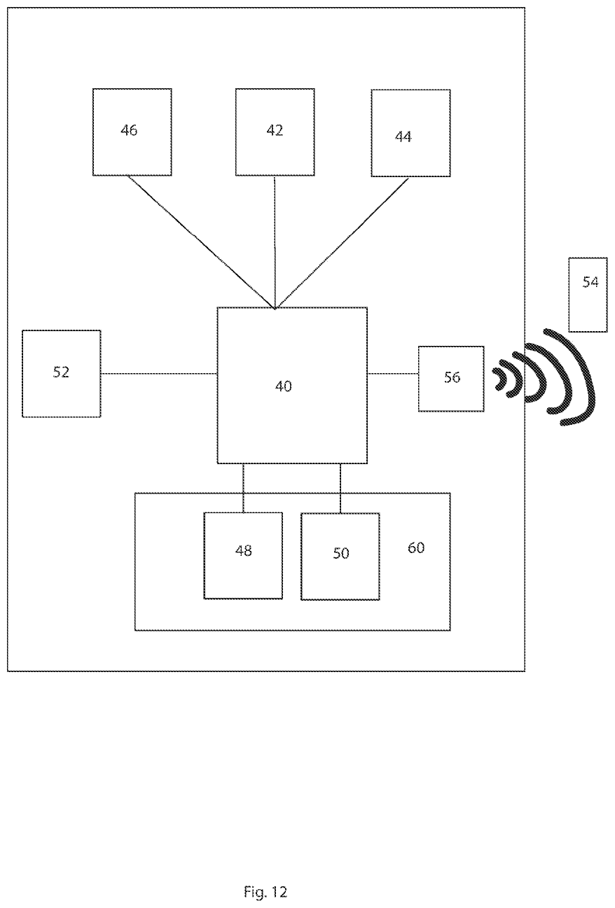

Referring to FIG. 12 in order to provide a control system 38, trailer 20 comprises a number of electronic sensors for feeding input into the control system. In particular 1× two axis sensor 42 for measuring for roll angle (a) and pitch angle (β) of trailer bed 22, 2× single axis sensors 44 for each loading ramp 24 angle (81, 82) and 2× or more single axis sensors 46 for suspension arms angle (left & right). These are connected via CANBUS to controller 40 which is also in communication with control board 60 which is depicted in FIG. 8. Control board 60 contains a plurality of lights or indicators 48 together with buttons and inputs 50. These can be used to control the operation of the trailer 20 via the hydraulic system depicted in FIG. 11 which is connected to the controller via the hydraulic flow valves 52. Control board 60 can be placed anywhere on the trailer 12 however preferably it is placed on the rear of the trailer 20. Indicator panels such as those shown in FIG. 10 can be placed elsewhere in on the trailer or in the vehicle by way of wireless or wired connection.

The buttons, switches and other inputs on the control board 60 include:—
1× park brake signal
1× off/manual/auto switch
1× auto ride-height pushbutton
4× override up/down pushbuttons

The outputs of controller 40 include:
4× hydraulic control valves, levelling suspension hydraulic cylinders (left and right)
Warning Signal Outputs:
i. trailer level status (green, yellow, red)
ii. control system status/malfunction (green, red)
iii. loading ramps level status (green, yellow, red)
iv. ride height status (green, red)
v. float ramp status (green, red)

The trailer 20 may also be remotely operated via controls input on a smartphone 54 or other mobile computing device via Wi-Fi/Bluetooth/RF modem 56 connected to controller 40 which can additionally display the trailer status to the operator. All components (processor unit, Wi-Fi modem, inclination sensors, control valves, control box, switches and signal lights) must be weather, moisture, salt spray, vibration, shock resistance for transport shocks and conditions on roads.

Controller 40 outputs real-time messages for tilt, uphill/downhill and loading ramp angles and warning. Whilst the buttons and indicators allow an operator to control the operation of each hydraulically operated cylinder or actuator, in a preferred embodiment, the controller 40 automates much of this functionality. Angle parameters (a, b, c, d, e, f) as set out in the algorithms set out below shall be user definable or programmable and customizable for certain machinery.

The following method steps are included in a second aspect of the invention:—
Controller receive pitch (uphill and downhill) and roll (crossfall or road camber) information and match that against pre-set matrix of safe loading parameters.
Controller receive pitch and roll information and match that against pre-set matrix of safe unloading parameters (these may be different to loading as the risks may be different).
Controller provide visualisation of trailer status and or indicate through simple traffic light system or similar including actual angles measured in truck cabin (or smartphone or similar) the following status:
a. Safe to load as is (level or acceptable parameters)
b. Safe to load using winch
c. Safe to load after levelling
d. Safe to load after levelling using winch
Once in a suitable location, use Smartphone or Control Board to control hydraulic functions whilst receiving pitch and roll information.

The following are additional optional steps of the method:—
Controller receive pitch (uphill and downhill) and roll (crossfall or road camber) information and match that against pre-set matrix of safe loading parameters.
Controller receive pitch and roll information and match that against pre-set matrix of safe unloading parameters.

The Controller, by type, model and or specific plant number, providing the following information to the operator:
a. Trailer configuration. How far to widen, if applicable;
b. Loading position on trailer to achieve correct axle weight distribution;
c. Load restraint information (and attachments, if any): and
d. Other information like close and lock all doors and windows, place boom down, check boom height etc.
Controller can provide suitable road route and or no go zones based on time calculations for the trip, weight and dimensions.
Controller may also specify compliance requirements for escort vehicles, police and electricity companies.
Controller producing Safe Work Method Statement (SWMS) and workflow related checklists to complete.
Controller outputting audit data for loading and unloading parameters, SWMS, checklists etc. This can be incorporated into systems for Chain of Responsibility (CoR) proof of compliance.

### Detailed Steps and Algorithms

Controller 40 receives park brake signal (ON) and activates the system.
Controller receives auto levelling signal from control panel 60 or remote user 54.
Controller receives sensor information, if |α|>a then calculates LIH, drop suspension cylinders (5) at high side to zero and lower or raise to LIH for suspension cylinders (5) at low side.
Controller receives the signal from control panel 60 or remote user 54, then adjust suspension cylinders (5) at trailer ride height 954 mm and send signal to ride-height light (green) for driving on road.

In addition, controller 40 reads sensors 42, 44 and 46 and send signal to warning lights located in control board 60 and send this information via CAN BUS and Wi-Fi modem (2) to mobile user 54.

Parameters for friction force calculation on a side slope:
1. a (degree) side slope angle from horizontal
2. μs static friction coefficient
3. μd dynamic friction coefficient
4. m (kg) equipment mass

As proven μₛ>μd. Therefore, sliding sideways due to a side slope will reduce friction force significantly during loading and unloading on a trailer.

Without sideways sliding, the friction force (static) shall be greater than gravitational force (sideways): F_{f}>F_{g}→m.g. cos(α). μₛ>m.g. sin(α)→μₛ>tan(α). Therefore, allowable side slope angle (a) for loading/unloading is acceptable when tan(α) is less than the static friction coefficient (βs).

For example: Loading/unloading a steel smooth drum roller on a trailer with steel loading ramps has a static friction coefficient of 0.2 according to the National Transport Commission, Load Restraint Guide 2018 (Australia) on page 243. Therefore, tan(α)<p s tan(α)<0.2→α<11.3°

Furthermore, the static friction coefficient can be significantly reduced by soil, dirt, grease, oil and water on the contact area. In this case, a safety factor of 2 or greater should be considered.

For example: Pads on a padfoot roller's drum can impact the ramps and or trailer deck non-symmetrically (right bias impact followed by left bias impact) causing the trailer to roll in a rocking motion through movement of the suspension (if non-hydraulic suspension is fitted). This impact force is greater for non-symmetric padfoot drums and it will increase sharply with increased driving speed. This sideways movement will reduce the allowable sideway angle for loading and unloading a padfoot roller.

Formula for rocking and rolling: Impact force x displacement=mass x gravity x falling height

A Schema for indicators and the operation of the apparatus and method described in FIG. 10 are as follows:

1. For System Status:
Green if there is no fault in control unit system
Red if there is a fault

2. For uphill/downhill angle (I3), compare with d,e parameter inputs:—
Uphill:—
   solid Green if β≤d
   solid Yellow if d<β≤e
   solid Red if β>e
For initial testing:
d=2°→if β≤2→solid Green
e=15°→if 2°<β15°→solid Yellow if β>15°→solid Red
Downhill:—
   solid Green if β≤−d
   solid Red if β>−d For initial testing:—
if β−2°→solid Green if β>−2°→solid Red

3. For tilt angle (α), compare with a,b,c parameter inputs:—
solid Green if |α|≤α
blinking Green if a<|α|≤b→Deck levelling required
blinking Yellow if b<∥α|≤c→Deck levelling required
solid Red if |α|>c→Site is not suitable for loading/unloading
solid Yellow if a<|α| b
For initial testing:
a=0.5°→if absolute value of |+−α|≤0.5°→solid Green
b=5.5°→if 0.5°<|α| 5.5°→blinking Green+solid Yellow c=10°→if 5.5°<|α| 10°→blinking Yellow

4. For loading ramps level (θ1, θ2), compare with f parameter input:—
solid Green if 1θ1-θ21 f
solid Red if 1θ1-θ21>f
For initial testing:—
f=0.5°
if 1θ1-θ21≤0.5°→solid Green
if 1θ1-θ21>0.5°→solid Red

5. For Float Ramps:—
Green if switch is on float position
Red if switch is off

6. For Ride Height:
Green if trailer deck height=954±10 mm
Red if not

Note: it requires an additional outlet terminal on trailer for these lights (Green+Red) mounted inside cabin.

7. Traffic light indicates item1 (System Status) AND item2 (uphill/downhill) AND item3 (tilt angle) AND item4 (loading ramps) AND items (Float Ramps)
solid Green

IF solid Green(item1) AND solid Green(item2) AND solid Green(item3) AND solid Green(item4)
blinking Green

IF blinking Green(item3)
solid Yellow

IF solid Yellow(item2) OR solid Yellow(item3)
blinking Yellow

IF blinking Yellow(item3)
solid Red

IF solid Red(item1) OR solid Red(item2) OR solid Red(item3) OR Red(item4) THEN turn off Green and Yellow
blinking Red

IF solid Red(item5)

### INDUSTRIAL APPLICABILITY

The present invention has applicability in the field of vehicle transportation devices including trucks and associated trailers.

1. A heavy vehicle and machinery trailer, the trailer comprising:
a trailer base having a plurality of wheels and suspension means;
a trailer bed supported on the trailer base by the suspension means; and
loading ramps connected to the trailer bed;
wherein the suspension means, or other methods such as hydraulically operated landing legs, are adapted to allow an operator to alter the pitch and/or roll angle of the trailer bed relative to the ground surface and wherein the loading ramps are adapted to have varying lengths such that when they are extended to the ground on a sloped surface, the lengths can be adjusted so that the ramps are evenly pitched.

2. The heavy vehicle and machinery trailer of claim 1, wherein the suspension means includes air bag suspension, spring suspension or hydraulic suspension.

3. The heavy vehicle and machinery trailer of claim 2 which additionally comprises widening means which allow an operator to widen the trailer bed to allow a wide vehicle or piece of machinery to be loaded onto the trailer bed.

4. The heavy vehicle and machinery trailer of claim 3 wherein the trailer widening of the trailer bed, extension of the trailer loading ramps and the levelling of the trailer bed is achieved by actuating a hydraulic system of the trailer.

5. The heavy vehicle and machinery trailer of claim 4 wherein the trailer further comprises at least one two axis sensor for measuring for roll angle (α) and pitch angle (β) of trader bed, at least two single axis sensors for each loading ramp angle and at least two or more single axis sensors for each suspension arms angle.

6. The heavy vehicle and machinery trailer of claim 5 wherein the trailer further comprises a controller for controlling the actuation of the hydraulic system of the trailer including the suspension means, widening means and/or ramp extension.

7. The heavy vehicle and machinery trailer of claim 6 wherein the hydraulic system is under the command of a controller that is operated by a user and which is in electrical connection with the plurality of sensors.

8. The heavy vehicle and machinery trailer of claim 7 wherein the commands of the user are input via at least a control panel comprising switches and indicators for indicating the safety or otherwise of the proposed conditions for loading or unloading a vehicle or machinery.

9. The heavy vehicle and machinery trailer of claim 8 wherein the controller is adapted to automatically level the bed of the trailer using the sensed input from at least one of the plurality of sensors.

10. The heavy vehicle and machinery trailer of claim 9 wherein the control system has programmed into it, a pre-set matrix of safe loading or safe unloading parameters by which the controller can compare against values sensed by at least one of the plurality of sensors.

11. The heavy vehicle and machinery trailer claim 7, wherein the controller is able to be operated remotely by way of Wifi/Bluetooth or RF connected remote device including smartphone.

12. A method of loading and unloading heavy plant or machinery onto a trailer, the method comprising:
1. Adjusting the pitch and roll angle of the trailer bed until horizontal;
2. Lowering ramps of the trailer;
3. When the first ramp on higher ground makes contact, matching the pitch angle of the second ramp to the first ramp and extend the ramp foot until it becomes grounded, and
4. Loading the vehicle (optionally with winch).

13. The method of claim 12 wherein the method includes the additional steps of:—determining whether it is safe to unload or load the trailer (optionally based on the specific type and model of machinery to be loaded);
levelling the trailer bed; and/or
lowering and extending the ramps; and/or
preparing the trailer to drive on the road after loading.

14. The method of claim 13 wherein determining whether it is safe to unload or load the trailer is performed by the controller by references to the sensed parameters when compared against a pre-set matrix of safe loading or unloading parameters.
